(19) United States
(12) Patent Application Publication
(10) Pub. No.: US 2016/0193854 A1
(43) Pub. Date: Jul. 7, 2016

(54) PRINTING DEVICE

(71) Applicant: RYONET CORPORATION, Vancouver, WA (US)

(72) Inventors: Ryan Moor, Battle Ground, WA (US); Mitchell Roberts, Battle Ground, WA (US); Liborio Roberto Panico, North York (CA)

(21) Appl. No.: 14/990,648

(22) Filed: Jan. 7, 2016

Related U.S. Application Data
(60) Provisional application No. 62/100,594, filed on Jan. 7, 2015.

(51) Int. Cl. B41J 11/00; B41J 3/407

(52) U.S. Cl. CPC B41J 11/002; B41J 3/4078

(57) ABSTRACT

Systems and methods for garment decoration utilizing a printing apparatus having a print table configured to receive a print substrate, such as a fabric or transfer sheet, a print head to eject ink onto said print substrate, and a plurality of axes for multi-directional movement for two and three dimensional printing. The printing apparatus further includes a curing unit for simultaneous printing and curing.

### CROSS-REFERENCE TO RELATED APPLICATIONS

The present application claims the benefit of U.S. Provisional Application No. 62/100,594, filed Jan. 7, 2015, which application is incorporated herein by reference.

### FIELD

The embodiments described herein relate generally to garment decoration and, more particularly, to printer based systems and methods that facilitate garment decoration.

### BACKGROUND INFORMATION

For many decades, the most widely used method for printing text or graphics on clothing has been screen printing. A screen has frame, usually of wood or metal, with mesh tightly attached to it. The mesh is impregnated with an emulsion that supports an ink blocking stencil of a desired image, the stencil being areas of mesh with the emulsion removed. A squeegee is moved across the screen, pushing ink into the mesh openings for transfer by capillary action to a substrate (e.g. a garment) during the squeegee stroke. The screen printing process involves art preparation, screen making, screen registration, screen printing, garment curing, and screen cleanup.

Various forms of three-dimensional printing (“3D Printing”), more generally known as additive manufacturing, have been used for several decades to prototype designs for objects and for one-off or small batch manufacturing with little or no tooling cost. Several methods of 3D Printing include Fused Deposition Modeling (see, e.g., U.S. Pat. Nos. 5,121,329, 5,340,433, and the like), also sometimes known as Fused Filament Fabrication, selective sintering, and stereo lithography.

Fused Deposition Modeling utilizes a computer numerical control (CNC) system to position and move a print head assembly that includes a heated nozzle and a drive mechanism that pushes feedstock into and through the nozzle. Feedstock for Fused Deposition Modeling implementations is usually a thermoplastic or other polymer material. The nozzle is moved relative to a build surface and the feedstock is driven through the nozzle to deposit material to create the part, usually in successive two-dimensional layers.

Advantages of additive manufacturing over other (usually subtractive) automated manufacturing technologies include low tooling cost, economical small batch or one-off production, fast turnaround from design to prototype, low labor costs, and little or no increased cost for arbitrarily complex part geometries.

Printing directly onto a garment using an inkjet printer has become a growing and competitive industry in the garment decoration space over the last few years. Though Direct to Garment (DTG) technology has had challenges due to the complexities of printing white ink through an inkjet print head, the technology is continuing to improve. There are multiple manufacturers of these printers, most of which use Epson or Ricoh print heads and drivers as internal components. Some companies such as Brother Corporation have developed their own print head specifically made for this purpose. DTG printing is higher cost per garment than screen printing, but can be economical for low volume production runs of a particular print design that otherwise would not justify the expense of making the necessary screens. DTG printers have a relatively high capital cost compared to the capital cost of equipment required for other garment printing methods such as screen printing. DTG printers are also limited to the color and substrate construction they can print on. DTG printers need dark cotton fabrics pre-treated and heat pressed prior to printing to matte the fibers of the fabric down giving the thin aqueous ink and base to print on. Also DTG printers are currently confined to print on primarily organic fabrics or light colored synthetic fabrics, no printer or method currently exists to effectively print on dark color synthetic fabrics. The DTG printing process involves art preparation, substrate preparation, inkjet printing, and heat curing.

Decorating a garment with Cad Cut Heat Applied Transfers (CCHAT) have grown to become a widely used method in the industry. CCHAT are created by contour cutting a heat applied vinyl comprised of a polyurethane (PU) material adhered to a carrier sheet, which material typically is provided in a roll format. A Vinyl Plotter is used to cad cut vector image lines into the PU surface of the transfer. After this the user weeds the negative space of the transfer from the transfer using a picker. The transfer can then be aligned to a garment and heat pressed on using between 20-40 lbs of pressure and pressed a temperature and time of 300-330 degrees Fahrenheit (° F.) for 10-12 seconds. After the initial press, a second color can be laid next to or on top of the first transfer which allows for multiple color transfers. The CCHAT process involves art preparation, image plotting or cad cutting, transfer weeding, and heat presses

In light of the foregoing, it is, therefore, desirable to provide improved systems and methods for garment decoration.

### SUMMARY

The various embodiments provided herein are generally directed to systems and methods that facilitate garment decoration. The systems and methods discussed herein, which enable fusion of text and graphics to a substrate utilizing printing based technologies, referred to hereinafter as SubFusion Printing, are a time saving, cost effective way to decorate a garment. The SubFusion Printing process opens up the door to costs savings and design possibilities not yet achieved by any prior form of garment decoration. The SubFusion Printing process involves art preparation, garment printing or transfer printing, and heat presses (optional when using a heat transfer). This enables a printer to decorate a sale ready garment in 2-3 steps versus 4-6 steps used in conventional processes.

In one embodiment, a printing apparatus for forming text or graphics on a print substrate having two or more axes of movement includes a carriage unit that holds a print head, a print head to eject ink onto a fabric or transfer sheet, and a print table configured to receive a print substrate. The print head may include one or more nozzle sizes, and one or more nozzle groups for multicolor printing.

In another embodiment, a printing apparatus for forming text or graphics on a print substrate configured for multi-axis directional movement includes a print head configured to eject ink onto a print substrate, a print table configured to receive a print substrate, and a ink curing unit comprising, e.g., an electrical resistance heating element, a radiant heating element, or a heated print table.

In yet another embodiment, a printing apparatus for forming text or graphics on a print substrate configured for multi-axis directional movement includes a print head configured to eject ink onto a print substrate, a print table configured to receive a print substrate and a locking mechanism configured to secure a print substrate to the print table.

In yet another embodiment, a printing apparatus for forming text or graphics on a print substrate utilizes an ink mixture comprising a screen printing ink or the like that is printable on a substrate, such as fabric or paper, and a low or quick cure catalyst that is integrated with the ink. The low or quick cure catalyst is a curing additive that when integrated with the ink reduces the temperature at which the ink cures and, in certain instances, the time it takes to cure the ink. The ink mixture is provided in sealed cartridges or supply bags that feed the ink to the print head. The printing apparatus also includes a heated bed to receive the ink and gel set or cure the ink, and a heating element to set the ink to a final cure point.

In yet another embodiment, a printing apparatus for forming text or graphics on a print substrate includes a multi-point feeding system that mixes a low or quick cure catalyst inline as the ink feeds out the print head. The printing apparatus also includes a heated bed to receive the ink and gel set or cure the ink, and a heating element to set the ink to a final cure point.

When compared to Direct to Garment (DTG) Printing, SubFusion Printing enables a garment decorator to accomplish a printed garment with less steps than traditional inkjet DTG Printing and cad cut heat applied transfer (CCHAT) methods. Unlike DTG Printing, SubFusion Printing allows printing directly onto a light or dark garment with the print material without the need for a pre-treatment of the garment to matte the fibers of the garment down.

SubFusion Printing also enables the printing of multiple colors and constructions of fabric by using a screen printing ink material or the like that is best matched to the fabric construction of the garment. This enables a user to print athletic fabrics constructed of polyesters which are very difficult if not impossible to print on with a DTG. SubFusion Printing directly to a garment also has the option to expedite the curing process as curing is accomplished concurrent to the printing process. This aspect once again speeds up the production process and lowers the expense by limiting the use of electricity.

When compared to CCHAT methods, SubFusion Printing accomplishes similar results while providing the user multiple advantages. Unlike CCHAT, SubFusion Printing only consumes the amount of printed material that is needed for the design. This not only conserves material with minimal waste, but also speeds up the process as there is no weeding of material needed prior to transfer to garment.

SubFusion Printing also enables for inline stacking of multiple colors per design to be accomplished in one printing cycle. This allows for precise registration of color and saves time versus manually lining up of colors after they are cad cut and transferred.

SubFusion Printing enables a user to add three dimensional (3D) geometric images directly onto fabric and specifically add variable height, shape, and depth in the same design.

SubFusion Printing enables a user to print reactive designs onto a garment by using heat, energy, or light conductive materials.

SubFusion Printing Direct To Substrate versus To Transfer Sheet: An advantage of SubFusion Printing is the ability to print directly to a substrate which negates the additional step and cost of transferring the design to the substrate using a transfer sheet. The advantage of using a SubFusion Printer to create a heat transfer is that it allows the user to create multiple transfers ahead of time and then transfer them to the garment at a later date using a heat transfer press.

SubFusion Printing Ink Material Chemistry: Unlike conventional ink materials which take a curing heat temperature of about 320° F. and a curing time of up to about 120 seconds to cure using a convection conveyor oven, the ink material used in SubFusion Printing, which integrates a low or quick cure catalyst additive with a screen printing ink, is able to cure at temperatures well below that of conventional ink material. Depending on the ink and curing additive used, the curing heat temperature for the particular ink may be reduced in a range of about 25 to 35% and in certain embodiments the curing temperature was reduced greater than about 30%. In one instance, the ink material used in SubFusion Printing was able to cure at about 220° F. using an inline heating element or warming print bed. SubFusion ink material is formulated by mixing a low cure catalyst into the ink either a) during the manufacturing process and sealing the ink material in an air free environment, or b) at the time of printing by using an inline feeding system with hoses.

Cost of production: SubFusion ink materials are manufactured, distributed to the printer, and deposited on the substrate much simpler than comparable processes. This allows the cost of consumable to be considerably lower than DTG and other decoration inks which drastically lowers the cost to produce a garment.

In-unit curing mechanism: Conventional direct to garment applications require an additional curing step outside of the printing application itself. SubFusion Printing enables the print to be cured during the printing process. Allowing for both a more streamlined processes as well as the opportunity to layer prints for 3D objects on the garment. This heating mechanism may consist of, but is not limited to, an electrical resistance heating element, a radiant heating element, or a heated print table or bed.

Other systems, methods, features and advantages of the example embodiments will be or will become apparent to one with skill in the art upon examination of the following figures and detailed description.

### BRIEF DESCRIPTION OF THE FIGURES

The accompanying drawings, which are included as part of the present specification, illustrate the presently preferred embodiment and, together with the general description given above and the detailed description of the preferred embodiment given below, serve to explain and teach the principles of the present invention.

FIG. 1 is a perspective view of an entire Printing Device 1 according to an embodiment presented herein.

FIG. 2 is a perspective view of a print table 2 and Z axis 6 according to an embodiment presented herein.

FIG. 3 is a perspective view of a carriage 11 according to an embodiment presented herein.

FIG. 4 is a perspective view of a print head 9, a pump 3, and an ink reservoir 4 according to an embodiment presented herein.

FIG. 5 is a block diagram to illustrate an electrical configuration of the printing device according to an embodiment presented herein.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### BRIEF DESCRIPTION

Each of the additional features and teachings disclosed below can be utilized separately or in conjunction with other features and teachings to provide systems and methods directed to the fusion of text and graphics to a substrate utilizing printing based technologies. Representative examples of the embodiments described herein, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

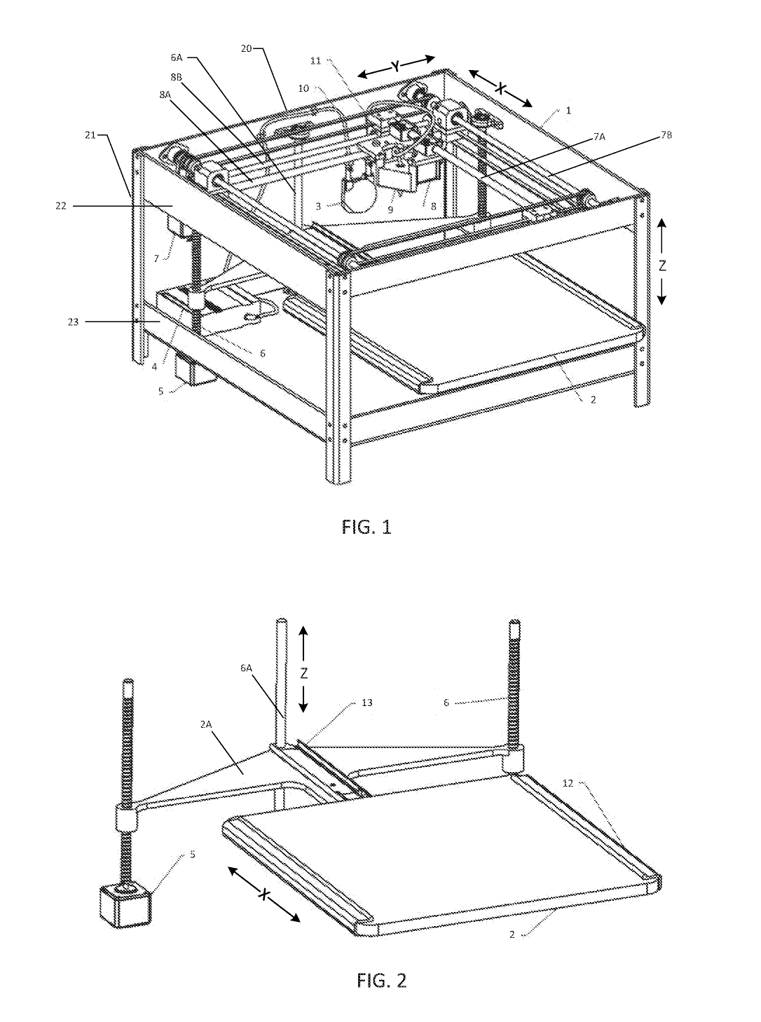

The various embodiments provided herein are generally directed to systems and methods to systems and methods that facilitate garment decoration. The systems and methods discussed herein, which enable fusion of text and graphics to a substrate utilizing printing based technologies, are referred to as SubFusion Printing. In a preferred embodiment, SubFusion Printing, comprises, as shown in FIG. 1, a printing apparatus 1 having multiple axes of movement. The printing apparatus 1 includes a print table 2, an ink reservoir 4, a pump 3, a print carriage 11, and a print head 9. The printing apparatus 1 is configured to enable fusion of text and graphics onto a substrate by data transmitted from a personal computer 24 (see FIG. 5). The print table 2, ink reservoir 4, pump 3, print carriage 11, and print head 9 are coupled to a housing 20. The housing 20 includes upper and lower frame bodies 22 and 23 vertically spaced apart and coupled to four elongate, vertically extending frame posts 21. The upper and lower frame bodies 22 and 23 comprise four flat panels arranged in a rectangular shape and coupled at their corners to the frame posts 21.

Referring to FIG. 2, the print table 2 is shown slidably coupled to a print table carriage 2A by way of a linear rail 13, allowing the user to slide the print table 2 outwardly toward the user and inwardly in an X direction. The print table carriage 2A is further shown slidably coupled to a print substrate Z-axis guide rod 6A enabling the print table 2 and, thus, a print substrate, to move primarily in an upward and a downward vertical or Z direction. The print table carriage 2A is further shown operably coupled to a pair of Z-axis drive screws 6 coupled to vertical axis motors 5 to drive the print table 2 upwardly and downwardly in a Z direction.

The print table 2 includes a holding mechanism 12 such as, e.g., elongate clamps, positioned along opposing edges to affix a print substrate to the print table 2.

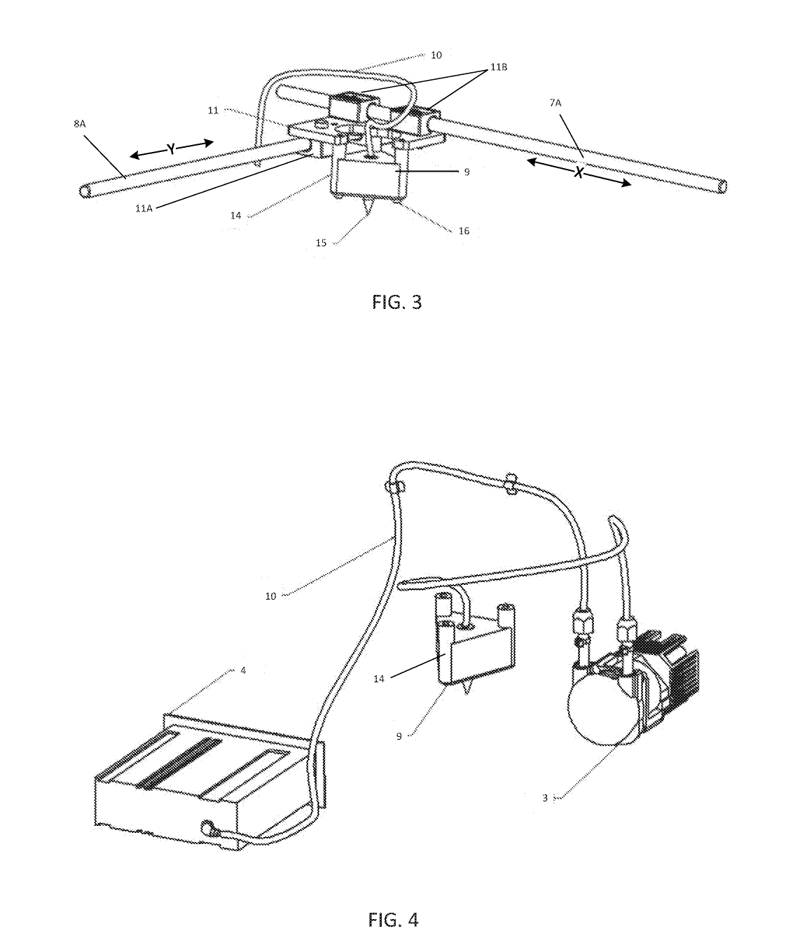

Referring to FIG. 3, a print carriage 11 is shown holding the print head 9 and slidably coupled via carriage couplings 11A and 11B to X- and Y-axis carriage guide rods 7A and 8A providing two horizontal axes of movement. As shown in FIG. 1, there is provided a carriage motor 7 operably coupled to X-axis drive screws 7B to drive the carriage 11 in primarily a front-to-back and back-to-front linear motion along the X-axis carriage guide rod 7A and a carriage motor 8 operably coupled to Y-axis drive screws 8B to drive the carriage 11 in primarily a left-to-right and right-to-left linear motion along the Y-axis carriage guide rod 8A.

The configuration of the print head 9 and carriage 11 being moveable in the X and Y direction enables the printing apparatus 1 to print two dimensional (2D) image or layer in the X-Y plane of the fabric or substrate. The configuration of the print table 2 being moveable in the Z direction enables the printing apparatus to print multiple layers at differing depths along the Z-axis and, thus, enables a user to add three dimensional (3D) geometric images directly onto the fabric or substrate and specifically add variable height, shape, and depth in the same design or image being printed on the fabric or substrate.

As depicted in FIG. 3, the print head 9 includes a tapered nozzle 15, a curing unit 16 such as, e.g., a radiant heating element, and a housing 14 mounted to the print carriage 11. The housing 14 connects the nozzle 15 to tubing 10 leading from the ink reservoir 4 and is attached to the underside of the carriage 11. For large inside diameter nozzles, a mesh is provided over the end of the nozzles to control ink flow.

In the various embodiments provided herein, the curing unit, which may be a curing unit 16 such as, e.g., a radiant heating element or a resistive heating element, coupled to the print head 9 and/or a heated print table 2, operates concurrently with the ejection of ink material from the print head 9 enabling simultaneous printing and curing of ink material on a fabric or substrate.

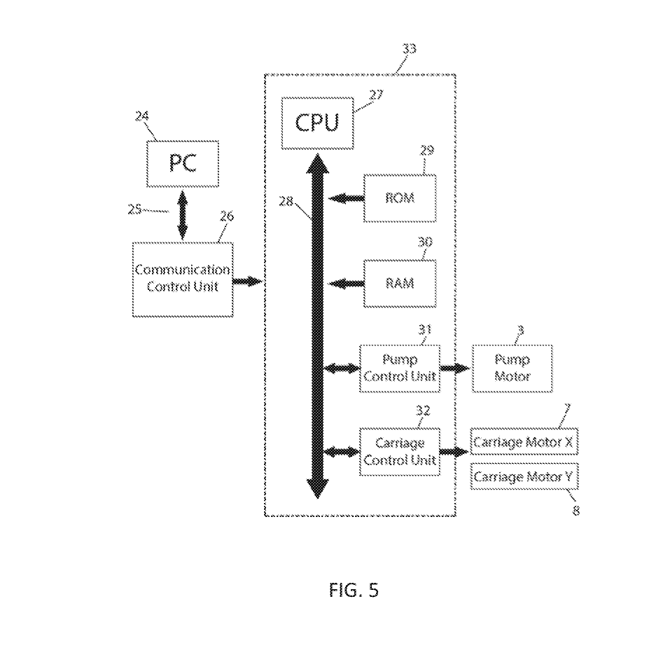

Referring to FIG. 4, a pump 3, which feeds ink from the ink reservoir 4 to the print head 9, is shown coupled to the ink reservoir 4 and print head 9 by way of tubing 10. The ink reservoir 4 preferably includes an ink bag (not shown) filled with ink that has been formulated with a low or quick cure catalyst that is fed into the print head 9 by way of the pump 3 and tubing 10.

In an alternative embodiment, a multi-point feeding system is provided that mixes a low or quick cure catalyst inline as the ink feeds out the print head. Accompanying the multi-point feeding system is a curing additive reservoir and a pump similar to the ink reservoir 4 and the ink pump 3 shown in FIGS. 1 and 4.

Referring to FIG. 5, an electrical configuration of the printing apparatus 1, will be described. FIG. 5 is a block diagram to illustrate the electrical configuration of the printing apparatus 1 according to the present embodiment. The printing apparatus 1 is provided with a print controlling unit 33, including a CPU 27, a ROM 29, a RAM 30, a pump control unit 31, a carriage control unit 32, which are connected to one another through a bus 28. The CPU 27 controls entire operations of the printing apparatus 1. The ROM 29 stores various controlling programs to be executed by the CPU 27. The RAM 30 temporarily stores various data. The pump control unit 31 controls the delivery of ink to the Print Head 9 by regulating the flow rate of the pump 3. The carriage control unit 32 controls movement of the carriage motors 7 and 8. Further, the printing apparatus 1 is provided with a communication unit 26, which connects the printing apparatus 1 with an external PC 24 through a USB 25. Optionally, the connection between the printing apparatus 1 and the external PC may be provided through a Bluetooth or WiFi interface.

Other variations to the above described multi-axis system, include, among other things: 1) articulated and delta robotic systems; 2) systems using 2.5 axis robotics; 3) systems using a plurality of nozzles; 4) systems using a plurality of ink reservoirs (for different ink colors); 5) systems using a heat curing unit; and the like.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

In the description above, for purposes of explanation only, specific nomenclature is set forth to provide a thorough understanding of the present disclosure. However, it will be apparent to one skilled in the art that these specific details are not required to practice the teachings of the present disclosure.

The various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter.

Systems and methods for garment decoration have been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art. For example, the reader is to understand that the specific ordering and combination of process actions described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A printing apparatus for forming text or graphics on a print substrate comprising
a carriage having two or more axes of movement,
a print head configured to eject ink onto a fabric or transfer sheet, the print head being coupled to the carriage,
a print head controller operably coupled to the carriage and the print head to control movement of the print head according to printing data corresponding to an image to be formed on a print substrate, and
a print table configured to receive a print substrate, wherein the print table having one or more axes of movement.

2. The printing apparatus of claim 1 wherein the print head includes one or more nozzles.

3. The printing apparatus of claim 2 wherein the print head includes one or more nozzle sizes.

4. The printing apparatus of claim 2 wherein one or more nozzles include a mesh positioned over the end of the nozzle to control ink flow.

5. The printing apparatus of claim 1 wherein the print head includes one or more nozzle groups for multicolor printing.

6. The printing apparatus of claims 1 further comprising an ink curing unit.

7. The printing apparatus of claim 6 wherein the ink curing unit comprises one or more of an electrical resistance heating element, a radiant heating element, and a heated print table.

8. The printing apparatus of claim 6 wherein the ink curing unit is coupled to the print head.

9. The printing apparatus of claim 8 wherein the ink curing unit comprises one or more of an electrical resistance heating element and a radiant heating element.

10. The printing apparatus of claim 1 further comprising an ink reservoir coupled to the print head.

11. The printing apparatus of claim 10 further comprising a pump interconnected to the ink reservoir and the print head via tubing to feed ink from ink reservoir to the print head.

12. The printing apparatus of claim 10 wherein the ink reservoir is filled with an ink that is integrated with a curing additive configured to lower the curing temperature of the ink.

13. The printing apparatus of claim 12 wherein the ink is held in one of sealed cartridges and supply bags.

14. The printing apparatus of claim 1 further comprising a multi-point feeding system configured to mix a curing additive inline as the ink feeds out of the print head.

15. A method of printing an image on a fabric or substrate comprising the steps of
ejecting ink material from a print head onto a fabric or substrate, and
curing the ink material on the fabric or substrate simultaneously with the step of ejecting ink from the print head onto the fabric or substrate.

16. The method of claim 15 further comprising the step of moving the print head along one or more of an X axis and a Y axis to eject ink material in a first two dimensional layer on the fabric or substrate.

17. The method of claim 16 further comprising the step of moving a print table to with the fabric or substrate is attached along a Z axis to eject ink material in a second two dimensional layer on the fabric or substrate.

18. The method of claim 15 wherein the ink material include a curing additive integrated into an ink to reduce the curing temperature of the ink.

19. The method of claim 18 further comprising the step of mixing the curing additive inline as the ink feeds out of the print head.

20. The method of claim 15 wherein the step of curing the ink material includes one of energizing a radiative heating element or a resistive heating element couple to the print head and heating a print table to which the fabric or substrate is attached.
